(19) United States
(12) Patent Application Publication
(10) Pub. No.: US 2025/0230975 A1
(43) Pub. Date: Jul. 17, 2025

(54) INTEGRATED LIQUEFIED NATURAL GAS (LNG) PRODUCTION FACILITY ON A GRAVITY-BASED STRUCTURE (GBS)

(71) Applicant: Publichnoe Aktsionernoe Obshchestvo "NOVATEK", Tarko-Sale (RU)

(72) Inventors: Leonid Viktorovich MIKHELSON, Moscow (RU); Valeriy Nikolaevich RETIVOV, Moscow (RU); Sergey Gennadyevich SOLOVYEV, Novyy Urengoy (RU)

(73) Assignee: Publichnoe Aktsionernoe Obshchestvo "NOVATEK", Tarko-Sale (RU)

(21) Appl. No.: 18/705,096

(22) PCT Filed: Sep. 22, 2022
(86) PCT No.: PCT/RU2022/000288

§ 371 Date: Apr. 26, 2024

(30) Foreign Application Priority Data
Nov. 24, 2021 (RU) 2021134310

(51) Int. Cl. F25J 1/02; F25J 1/00

(52) U.S. Cl. CPC F25J 1/0259; F25J 1/0022; F25J 1/0211; F25J 1/0278; F25J 2220/66; F25J 2270/66; F25J 2290/42; F25J 2290/72

(57) ABSTRACT

A liquefied natural gas (LNG) production complex includes a gravity-based structure (GBS), with liquid storage tanks inside and topside modules on the GBS top slab including interconnecting modules along the GBS top slab centerline, and equipment modules at least some of which are on each side. Equipment modules include: first row on one side: at least one module of reception installations, a condensate stabilization installation, and an acid gas removal installation, and at least one module of mixed refrigerant compressors, second row on the other side: modules of gas dehydration, mercury removal, wide fraction of light hydrocarbons extraction, fractionation and liquefaction installations, and at least one module of boil-off gas, fuel gas system and heating medium compressors; the equipment modules along the GBS short end include: one or more power plant modules, modules with the main technical room and emergency diesel generators, and auxiliary systems modules.

### TECHNICAL FIELD

The invention pertains to production facilities and can be used for development of near-shore and offshore integrated liquefied natural gas (LNG) production complexes on gravity-based structures.

### BACKGROUND ART

Now there are several types of near-shore and offshore hydrocarbon processing facilities, for instance natural gas liquefaction plants (LNG plants) on floating and gravity-based structures.

A common design is an LNG production complex, which is a floating natural gas extraction, treatment, liquefaction, LNG storage and offloading facility. Floating facilities for extraction, storage, and offloading of LNG (FLNGs) are used for offshore gas field developments and installed directly at an offshore field using anchoring and/or mooring. Such floating facilities are not operated in offshore locations with heavy ice conditions since their reliable positioning necessary to connect to underwater pipeline armature is impossible due to drifting ice. Floating LNG plant applications are limited to offshore field development projects in ice-free seas. Furthermore, production capacity of floating installations is limited by their size.

One example of an LNG plant on a gravity-based structure (GBS) is a near-shore LNG production, storage, and offloading plant (KR 20180051852 A, publication date: 17 May 2018) with production equipment installed on a top deck of the gravity-based structure comprising two rectangular prism-shaped steel caissons, the smaller inside the larger. The space between the caissons is filled with solid ballast. Inside the inner caisson, an LNG tank is installed. This design features the following disadvantages.
1. Since topside supports are on the inner caisson opposite sides, an installation deck, on which the topside is mounted, needs to be reinforced.
2. The GBS steel body is more prone to corrosion, which makes it less durable.
3. The GBS steel body needs to be significantly thick to withstand ice impacts, meaning greater metal consumption.
4. The solid ballast makes GBS ballasting/de-ballasting more challenging.
5. The rectangular prism-shaped GBS has large draft when transported to the installation site, which makes transportation through shallow water areas impossible.

There also exists a floating LNG plant with an LNG production equipment located on a ship top deck (KR 20130009064 A, publication date: 23 Jan. 2013). Along the top deck centerline, an overpass with pipelines is erected, along which equipment modules are located: a power generation module, a gas treatment module, and gas liquefaction modules on one side, an electrical equipment module, a dehydration module, an LNG offloading module, a boil-off gas module, and a main loading mechanisms module on the other side. The bow features living quarters and a turret, while the aft features a flare installation.

Since this design features an asymmetric module layout, ballasting and other design solutions are necessary for ship balancing purposes. Furthermore, the floating installation cannot operate in waters with ice conditions.

A complex design, which is the closest to the proposed one, features an offshore natural gas processing facility on a gravity-based structure (GBS) (WO 2021/106151 A1, publication date: Mar. 6, 2021) comprising a rectangular prism-shaped GBS with a base slab and a top slab, internal vertical walls and an intermediate slab, on which one or more LNG tanks are installed in one compartment, and also a ballast compartment stretching all along the GBS, and topside modules installed on supports on the top slab. One of the design options features a piping module along the top slab centerline with process equipment modules on its sides.

The disadvantage of this facility is that the piping module is much larger than the other topside modules, resulting in its complicated installation, and a distance between the modules for LNG pumps installation purposes is increased, which requires a larger facility with longer piping and cabling.

### SUMMARY OF THE INVENTION

The proposed invention offers a solution for the problem of increasing the arsenal of facilities for LNG production in near-shore waters with heavy ice conditions.

The technical result is the accomplishment of the invention intended use, i.e. LNG production using a complex on a gravity-based structure (GBS).

The technical result is achieved by a liquefied natural gas (LNG) production complex comprising a gravity-based structure (GBS), with the GBS top slab on which topside modules are located, including at least one interconnecting module along the top slab centerline, and equipment modules, at least some of which are lined up on each side of at least one interconnecting module, and liquid storage tanks being located inside the GBS, herewith, in accordance with the invention, the complex comprises interconnecting modules lined up along the top slab centerline, and the equipment modules include:
the first row on one side of the interconnecting modules:
at least one module of reception installations, a condensate stabilization installation, and an acid gas removal installation, and
at least one module of mixed refrigerant compressors,
   the second row on the other side of the interconnecting modules:
modules of gas dehydration, mercury removal, wide fraction of light hydrocarbons extraction, fractionation and liquefaction installations, as well as
at least one module of boil-off gas, fuel gas system and heating medium compressors;
   the equipment modules also include located along the GBS short end:
at least one power plant module,
at least one module with the main technical room and emergency diesel generators, and
at least one auxiliary systems module.

Besides, each topside module has a frame with braces, with equipment installed on its tiers.

In this case in each interconnecting module, a lower main tier accommodates local substations and control and measuring devices, an intermediate tier accommodates cable overpasses, an upper tier accommodates pipeline overpasses, and an open tier accommodates air-cooled heat exchangers located above all topside modules equipment.

It is advisable that the main technical room and emergency diesel generators module be installed in the same row as the interconnecting modules, and that its open tier accommodates air-cooled heat exchangers.

The preferable design features the GBS that has a central part and a protruding part, with the central part being a rectangular prism with the said top slab, the protruding part stretching along the central part sides all around its perimeter and having external vertical walls, the protruding part and the central part sharing the said base slab, and the protruding part being lower in height than the central part.

The GBS central part has internal longitudinal and transverse walls forming compartments, in some of which the said tanks are located and some of which are ballast compartments, while the GBS protruding part has internal walls being perpendicular to its external walls and forming compartments, some of which are ballast compartments.

Furthermore, some of the compartments formed by the GBS central part longitudinal and transverse walls accommodate auxiliary equipment.

Furthermore, the topside modules are mounted on supports located on the top slab above intersections of the GBS central part longitudinal and transverse walls.

### LIST OF DRAWINGS

FIG. 1 shows the layout of the proposed complex on the GBS from the top.

FIG. 2—A-A transverse cross-section of FIG. 2.

FIG. 3—B-B longitudinal cross-section of FIG. 2.

FIG. 4—C-C longitudinal cross-section of FIG. 2.

FIG. 5—layout of the GBS main compartments.

FIG. 6—layout of topside modules supports on the GBS top slab.

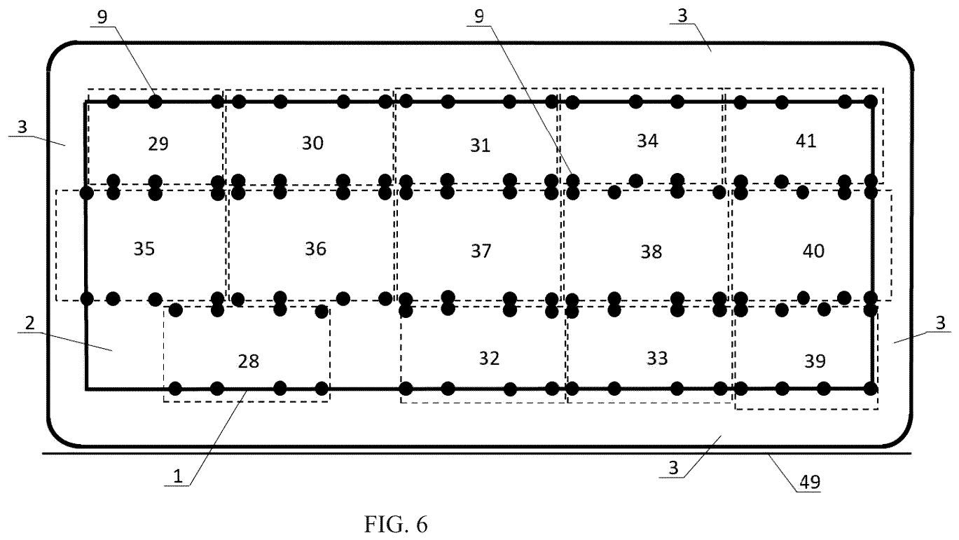

FIG. 7—layout of the topside modules load-bearing structures.

Items in the drawings are numbered as follows:
1—GBS central part
2—GBS top slab
3—GBS protruding part
4—GBS base slab
5—GBS vertical wall
6—main compartments for LNG storage tanks
7—inner ballast compartments
8—outer ballast compartments
9—topside support
10—seabed reinforcement near the quay
11—GBS underbase foundation
12—LNG storage tank
13—support slab for LNG storage tank 12
14—vertical wall under support slab 13
15—gas condensate storage tank (compartment)
16—auxiliary and engineering compartments
17—substandart gas condensate storage tank (compartment)
18—gasket
19—space between top slab 2 and topside modules 10
20—internal ballast compartments under support slab 13
21—module column
22—module vertical bracing
23—module floor beam (girder)
24—topside main deck
25—jetty for tankers
26—interconnecting piperack to shore
27—evacuation bridge
28—reception installation, condensate stabilization installation, and acid gas removal installation module
29—dehydration installation and mercury removal installation module
30—wide fraction of light hydrocarbons (WFLH) extraction, fractionation and liquefaction installations module
31—liquefaction installation module
32—mixed refrigerant compressor module (line A)
33—mixed refrigerant compressor module (line B)
34—boil-off gas, fuel gas system and heating medium compressors module
35—1st interconnecting module
36—2nd interconnecting module
37—3rd interconnecting module
38—4th interconnecting module
39—power station module
40—main technical room and emergency diesel generators module
41—auxiliary systems module
42—topside intermediate tier
43—topside upper tier
44—topside open tier
45—air cooled heat exchangers
46—piperacks on interconnecting modules
47—cable trays on interconnecting modules
48—local substations and control and measuring devices on interconnecting modules
49—quayside
50—seabed of a water body
51—water level in the water body

### EXAMPLES OF THE INVENTION IMPLEMENTATION

The liquefied natural gas (LNG) production complex on a gravity-based structure (GBS) is a prefabricated technical product comprising a set of process, utility and auxiliary equipment for production, storage and offloading of LNG and gas condensate.

The GBS LNG production complex is fabricated at a dedicated industrial site and then towed afloat to its installation site. The GBS is installed on a special underbase foundation on the seabed. To prevent scouring of the bed under the GBS and the bed of the water body, gabions or other similar devices may be placed on the bottom around the GBS. The GBS is installed near a dedicated quay and is connected to the shore with overpasses and bridges enabling installation of respective piping and cabling without resorting to underwater pipelines and/or long above-water overpasses, as well as ease of access to the production complex and swift personnel evacuation. The short distance to the shore enables a simpler and cheaper integration with onshore facilities, including the hydrocarbon field, from which is a source of raw hydrocarbons for the production complex.

The main components making up the complex are the gravity-based structure (GBS) and the topside-modularized process equipment.

The topside of the LNG production complex comprises modules, on which process and engineering equipment is mounted. Each module is an individual complete three-dimensional structure with process equipment and/or engineering equipment, piping, systems and networks intended to accomplish one or more LNG process stages or to support the process.

Modules are delivered to their installation location on the GBS as products with the required level of prefabrication. Modules installation onto the GBS is followed by modules integration in terms of hook-up to other modules and to GBS equipment installed beyond the topside.

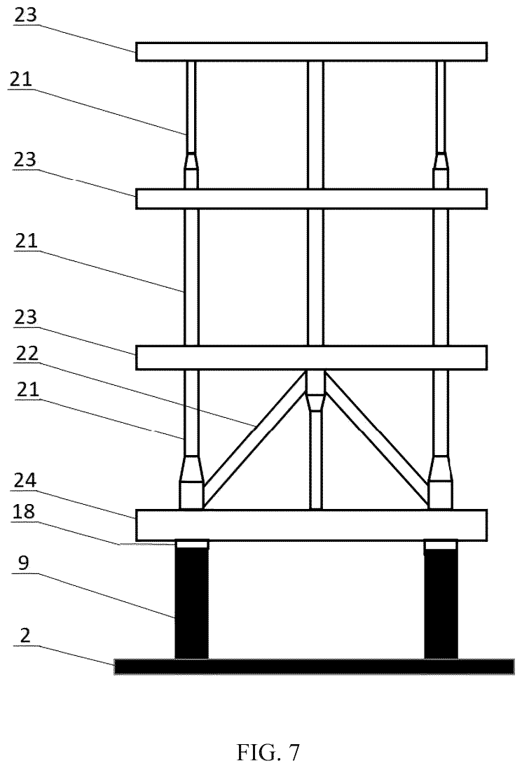

Structurally, each topside module 28-41 is a three-dimensional steel framework with bracings comprising several tiers, and inside the framework equipment is installed. The module framework with bracings (FIG. 7) primarily consists of vertical columns 21, vertical bracings 22, and floor beams 23 with horizontal bracings.

For ease of equipment maintenance and personnel access, each module has several tiers (decks). Each module is designed to have at least one stairwell for personnel movement between the tiers, and evacuation. Main tiers 24 of all modules are at the same height to combine evacuation routes and load transporting routs across the topside, thus reducing the load on GBS top slab 2. Other tiers 42-44 of the topside modules vary in height depending on their function and equipment. Transition bridges can be installed between tiers of adjacent modules.

Each module has its individual purpose as part of the LNG process and has its individual set of equipment. Depending on the equipment they contain, the modules can be equipment modules or interconnecting modules.

Equipment modules include:
process modules (seven in this case), in which main LNG processes are completed, and
engineering modules (three in this case), in which power sources and engineering systems are installed.

Interconnecting modules (four in this case) include piperacks and cable trays, local substations and control and measuring devices, as well as air cooled heat exchangers.

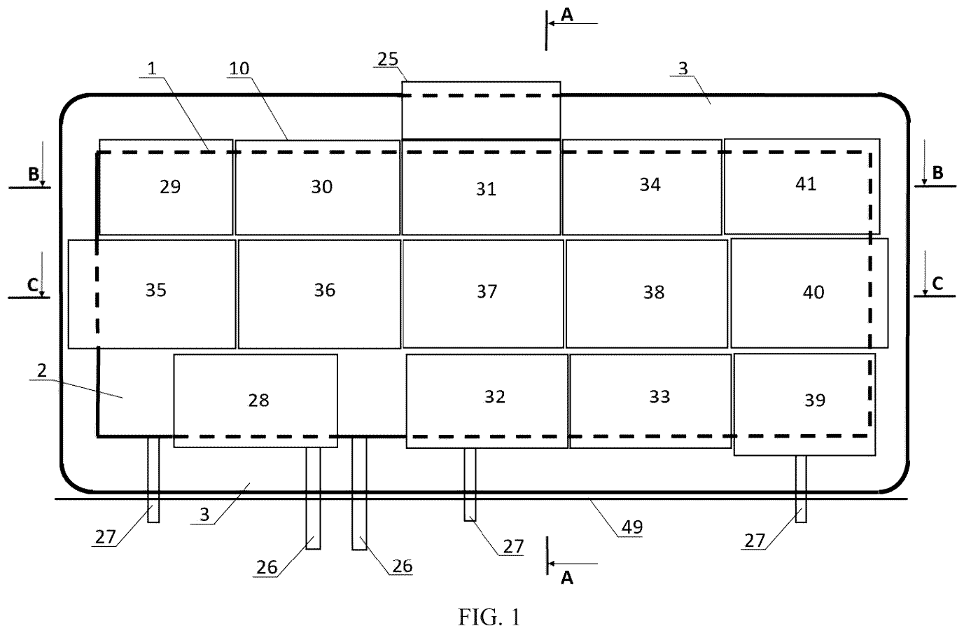

Process modules 28-34 are arranged as two rows on each side along GBS top slab 2, interconnecting modules 35-38 are located between the two rows along GBS top slab 2, and engineering modules 39-41 are concentrated at one of GBS short ends (FIG. 1).

This arrangement enables rational equipment layout in consistency with the LNG process sequence. The engineering modules are also separated from the rest of the topside by fire-proof and explosion-proof walls, and there are also fire-proof and explosion-proof walls between the process modules, which enables the shortest distance between the modules and smaller dimensions of the production complex while maintaining high level of fire and explosion safety.

### Process Modules (FIGS. 1 to 3):

1. Module 28 of reception installations, a condensate stabilization installation, and an acid gas removal installation, in which raw gas reception, pressure control, liquid condensate (hydrocarbons and water) separation, carbon dioxide, hydrogen sulphide and methanol removal from the raw gas, and gas condensate stabilization occur. Module 28 is installed on the shoreward side of the GBS.
2. Module 29 of gas dehydration, mercury removal installations, in which mercury, moisture and remaining methanol removal from the raw gas occurs.
3. Module 30 of wide fraction of light hydrocarbons (WFLH) extraction, fractionation installations, in which heavy hydrocarbon removal from the gas before its supply to liquefaction occurs. The resulting liquid hydrocarbons are stabilized and partially fractionated to obtain ethane, propane, and butane fractions.
4. Module 31 of liquefaction installation, in which the gas is cooled and throttled to produce liquefied natural gas (LNG).
   Modules 29, 30 and 31 are located along the seaward side of the GBS.
5. Mixed refrigerant compressor module 32 (line A), in which three different mixed refrigerants are treated and compressed using centrifugal compressors driven by gas turbines. Waste heat of the gas turbines flue gas can be recovered to heat up the heating media.
6. Mixed refrigerant compressor module 33 (line B), in which three different mixed refrigerants are treated and compressed using centrifugal compressors driven by gas turbines. Waste heat of the gas turbines flue gas can be recovered to heat up the heating media.
   Modules 32 and 33 are located on the shoreward side of the GBS.
7. Module 34 of boil-off gas, fuel gas system and heating medium compressors, in which boil-off gas compression and distribution, fuel gas treatment, heating media treatment and heating occur. Module 34 is installed on the seaward side of the GBS.

### Modules of Engineering Systems:

1. Power generation module 39, in which power is generated by gas turbine generators. Waste heat of the gas turbines' flue gas can be recovered to heat up the heating media.
2. Main technical room and emergency diesel generators module 40, in which uninterrupted power sources and control and measuring devices as well as air-cooled heat exchangers are located.
3. Module 41 of auxiliary systems, accommodating air supply and nitrogen supply systems-air compressors, air separation unit, air dryer, and other equipment.
   Modules 39, 40 and 41 are installed along a GBS short end.

The distribution of installations between the modules may vary. This is a description of one of the options of filling modules with equipment.

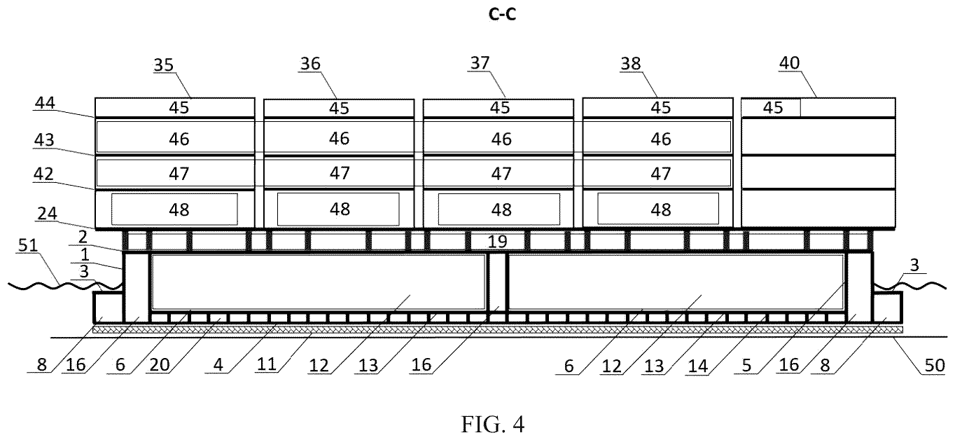

Interconnecting modules 35, 36, 37, 38 lined up along the GBS top slab have similar arrangement and set of equipment (FIG. 4):
Main tier 24 accommodates local substations and control and measuring devices 48,
Intermediate tier 42 accommodates cable overpasses 47,
Upper tier 43 accommodates pipeline overpasses 46,
Open tier 44 accommodates air-cooled heat exchangers 45.

However, each interconnecting module 35, 36, 37, 38 has an individual equipment composition depending on production processes occurring in adjacent process modules. For instance, local substations and control and measuring devices of module 48 support operation of equipment in process modules on either side of each interconnecting module 35, 36, 37, 38, thus enabling optimized switchgear layout and better equipment response time.

Having a significant part of cable and pipeline overpasses 46, 47 in interconnecting modules 35, 36, 37, 38 enables optimized piping and cabling interconnection between the modules, shorter cable runs and pipe runs, as well as extra space for equipment in the process modules.

Air-cooled heat exchangers 45 on open tier 44 of interconnecting modules 35, 36, 37, 38 are a part of process installations located in the process modules. Interconnecting modules 35, 36, 37, 38 are located in the topside central part along the GBS centerline and are higher than any of the adjacent process modules, with air-cooled heat exchangers 45 installed on open tier 44, which is the highest tier of interconnecting modules 35, 36, 37, 38. The installation of air-cooled heat exchangers 45 at the highest elevation of topside enables the most efficient heat dissipation.

Module 40 of technical room and emergency diesel generators is also located along the GBS centerline and is very tall, which is why it also accommodates air-cooled heat exchangers 45.

The GBS is a three-dimensional structure made from reinforced concrete, which functions as a storage for produced and processed feedstock, as well as for auxiliary substances and materials. It serves as a foundation for the topside of the production complex and is designed to be installed on seabed 50 of a water body with under its own weight. The central part 1 of the GBS is shaped as a rectangular prism and has top slab 2 (FIG. 1).

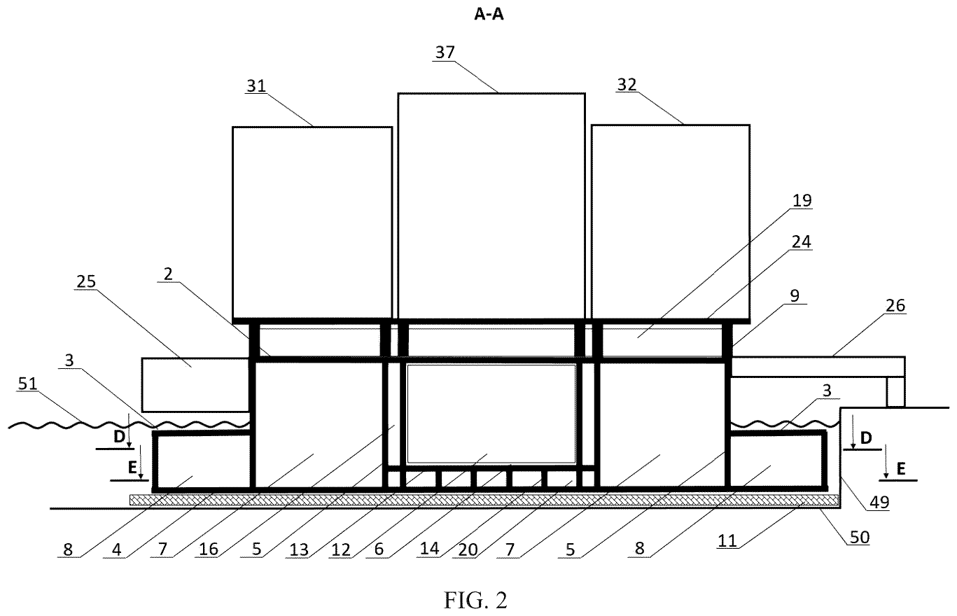

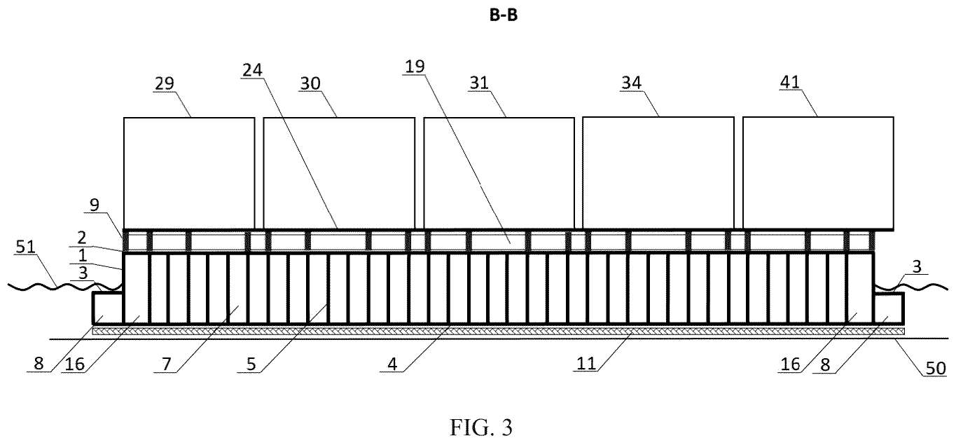

On the sides of central part 1 along the whole perimeter, GBS protruding part 3 with vertical outer walls is located. GBS central part 1 and protruding part 3 share same base slab 4, and protruding part 3 is lower than central part 1 (FIGS. 2 and 3).

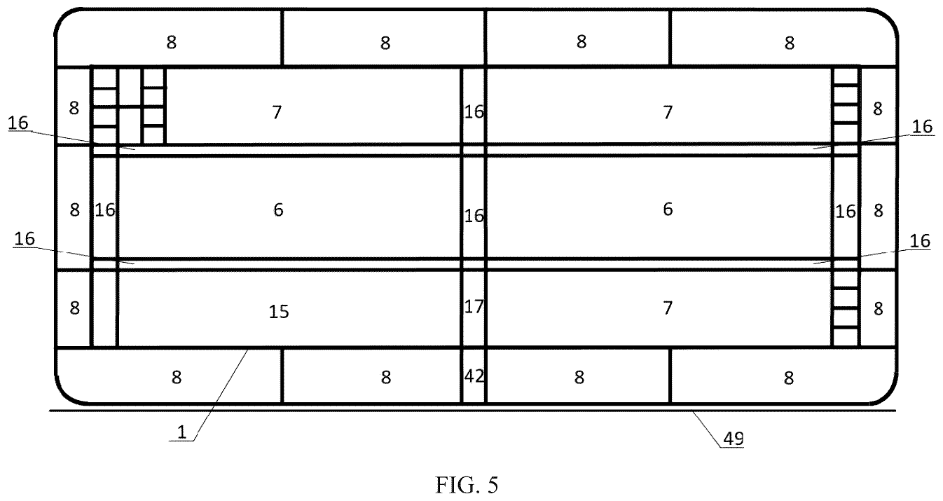

Central part 1 is broken down into compartments with vertical longitudinal and transverse walls 5 (FIGS. 2 to 5). Some of the compartments, e.g. compartments 6 and 15, are used for product (LNG and condensate) storage, while other compartments, e.g. compartments 7 and 20, are used for ballast water. GBS protruding part 3 is broken down into compartments with vertical walls 5 that are perpendicular to its external walls. Compartments 8 along the GBS perimeter are also included in the ballast system.

Top slab 2 has reinforced concrete supports 9, on which topside modules 28 to 41 are mounted.

A GBS can stay afloat during water transportation to the site of the integrated production complex and can withstand ice impact in ice conditions. Changing the GBS condition from floating to stationary at the site of installation on the foundation 11 is ensured by flooding the ballast compartments 7, 8 and 20 with water.

Since reinforced-concrete walls 5 also serve as load-bearing structures that transfer the load from the topside to support slab 13 and underbase foundation 11, topside supports 9 are located above the intersections of vertical longitudinal and transverse walls 5 of the GBS.

LNG, gas condensate, and consumables storage tanks are located inside the GBS compartments. GBS central part 1 has a number of tanks that may have different design depending on the properties of substances to be stored. Membrane tanks are used for LNG storage. In this case, tank 12 comprising a metal membrane made of stainless steel or invar (Fe—Ni alloy) separated from concrete structure by an insulation layer is installed inside concrete compartment 6 (FIGS. 2, 4). The insulation layer is located directly on top slab 2, intermediate slab 13 and GBS walls 5, transferring the loads from tank 12 and its LNG content to the above-mentioned boundary structures. The GBS slabs and walls thus serve as support structures for membrane tanks, with which they are integrated into a single structural unit. To prevent any leaks, the bottom and the side surfaces of membrane tanks 12 have a secondary barrier being an additional membrane installed inside the insulation layer.

LNG is stored in two 115,000-cbm tanks 12, each installed in a 135×40×24 m individual compartment 6.

Condensate may be stored in GBS concrete compartments 15 and 17, with their boundary structures serving as a barrier. 135×30×30 m stable condensate storage compartment 15 has a capacity of 75,000 cbm. 30×8×30 m compartment 17 is used for off-spec condensate storage and has a capacity of 5,000 cbm.

“Wet” storage involving an underlying water layer is used for condensate storage. In this case, the bottom layer of the stored product around 1 m in thickness is considered a commingling area ensuring guaranteed separation of water and the stored product during loading operations. Compartments 15 and 17 is also slightly pressurized (from the atmospheric pressure level) using a nitrogen cushion in the upper part of compartments to air-proof compartments 15 and 17 and prevent any flammable and explosive gas mixtures with hydrocarbon vapors from forming.

Self-supported tanks installed in the GBS compartments are used for waste water, demineralized water, wash water, absorber, butane and propane.

Tanks for various media (liquefied gas, diesel fuel, propane, butane, ethane, water) are located within the GBS as close as possible to the relevant modules where such media are used, allowing to optimize the lengths and masses of pipelines, electrical heat tracing, and insulation.

LNG and condensate offloading jetty 25 is structurally integrated with the GBS and the topside. Fenders and an offloading platform with loading arms as well as other marine and process equipment enabling LNG and condensate offloading are installed on protruding part 3 on the GBS seaward side. Mooring equipment for tanker berthing is installed on the GBS seaward side. The water area near the jetty 25 may have seabed reinforcement 10 protecting the bottom soil from scouring by ships propellers.

The integrated production complex on a gravity-based structure is connected to the shore by two overpasses 26 (FIGS. 1 and 2) on which pipelines and cable ways are laid. The pipelines connecting the production complex to the field and other facilities are equipped with cut-off valves at the overpasses landfall. There are also three evacuation bridges 27 (FIG. 1) used for personnel movement and evacuation, if needed. The overpasses and bridges are made of steel and mounted on supports. The supports are erected on GBS top slab 2 on one end, and on quayside 49 on the other. Seabed 50 and water level 52 in the body of water are shown on FIGS. 2 to 4.

The process technology of the LNG production complex on GBS has no fundamental differences from mixed refrigerant-based process technologies, which are used at onshore plants. Raw gas and condensate from the field are piped via overpass 26 to module 28 of reception installations, in which raw gas reception, pressure control, liquid condensate (hydrocarbons and water) separation, carbon dioxide, hydrogen sulphide, methanol, and other impurities removal from the raw gas, and gas condensate stabilization occur. The process employs air-cooled heat exchangers installed on the open tier of interconnecting module 35. The stabilized gas condensate is sent to storage tanks 15 and 17 accommodated inside the GBS, while the treated raw gas is sent to module 29 of gas dehydration and mercury removal where mercury, moisture, and remaining methanol are removed from the raw gas before it is sent to module 30 of wide fraction of light hydrocarbons (WFLH) extraction, fractionation installations. The process employs air-cooled heat exchangers installed on the open tier of interconnecting module 35. Module 30 of wide fraction of light hydrocarbons (WFLH) extraction, fractionation installations is used to extract heavy hydrocarbons before the treated gas transfer to liquefaction. The resulting liquid hydrocarbons are stabilized and partially fractionated to obtain ethane, propane, and butane fractions for the purposes of mixed refrigerant components replenishment. The GBS has dedicated tanks to store these components. Stabilized heavy hydrocarbons are sent to the gas condensate storage tanks. Once treated in modules 28-30, the gas is sent to module 31 of liquefaction installation where three coil-wound heat exchangers are installed one after another, which are used to cool the gas with subsequent throttling and generation of liquefied fraction (LNG) and boil-off gas. The liquefied gas is sent to LNG storage tanks 12 accommodated inside the GBS. Three mixed refrigerants with different composition (MR1, MR2, MR3), which are mixtures of nitrogen, methane, ethane, propane, and butane, are used for gas cooling in the heat exchangers. The process employs air-cooled heat exchangers 45 installed on the open tiers of interconnecting modules 36, 37, 38.

The mixed refrigerant treatment and compression occurs in mixed refrigerant compressors modules 32 and 33. The refrigerant is air-cooled downstream the compressor in air-cooled heat exchangers 45 in interconnecting modules 36, 37 & 38, through which the refrigerant circulates between module 31 of liquefaction installation and mixed refrigerant compressors modules 32 and 33.

Each of the three mixed refrigerant loops has two parallel lines, A and B, installed in different modules, with line A being installed in mixed refrigerant compressors module 32 and line B being installed in mixed refrigerant compressors module 33.

Both mixed refrigerant compressors modules 32 and 33 feature the same compressor arrangement, with the compressors capacity being based on a 2*50% operating mode, i.e. on 100% compressor backup. The MR1 and MR2 compressors in each of module 32 and module 33 are on the same shaft and the same baseframe, and are driven by the same gas turbine drive, therefore reducing the number of gas turbine drives.

The refrigerant is produced from ethane, propane, and butane extracted in module 30 of WFLH extraction, fractionation installations and stored in the GBS tanks for replenishment purposes. Nitrogen for refrigerant production is generated in module 41 of auxiliary systems. Methane replenishment is done using treated raw gas and boil-off gas.

Boil-off gas generated in module 31 of liquefaction installation, LNG storage tanks, and also in the gas carrier cargo tanks during offloading is sent to module 34 of boil-off gas, fuel gas system and heating medium compressors for boil-off gas compression and distribution. Boil-off gas is partially used for the treatment of fuel gas, which is primarily consumed by gas turbines in power station module 39 and mixed refrigerant compressors modules 32 and 33.

The gas turbines are equipped with waste heat recovery installations to recover waste heat to be used to heat up the heating medium. Excessive heat is evacuated from the heating medium system via air-cooled heat exchangers 45 mounted on the open tier of module 40 of main technical room and emergency diesel generators. Since the modules accommodating the gas turbines, the waste heat recovery installations, the fuel gas system and the heating medium system are packed together, less piping is required and efficient heat recovery is achieved.

The turbine drives of the mixed refrigerant compressors and the turbine generators use unified gas turbines simplifying, and reducing the cost of, equipment operation and maintenance.

1. A liquefied natural gas (LNG) production complex comprising a gravity-based structure (GBS), with the GBS top slab on which topside modules are located, including at least one interconnecting module along the top slab centerline, and equipment modules, at least some of which are lined up on each side of at least one interconnecting module, and liquid storage tanks being located inside the GBS, wherein the complex comprises interconnecting modules lined up along the top slab centerline, and the equipment modules include:
the first row on one side of the interconnecting modules:
at least one module of reception installations, a condensate stabilization installation, and an acid gas removal installation, and
at least one module of mixed refrigerant compressors,
the second row on the other side of the interconnecting modules:
modules of gas dehydration, mercury removal, wide fraction of light hydrocarbons extraction, fractionation and liquefaction installations, as well as
at least one module of boil-off gas, fuel gas system and heating medium compressors;
the equipment modules also include located along the GBS short end:
at least one power plant module,
at least one module with the main technical room and emergency diesel generators, and
at least one auxiliary systems module.

2. The complex according to claim 1, wherein each topside module has a frame with braces, with equipment installed on its tiers.

3. The complex according to claim 2, wherein in each interconnecting module, a lower main tier accommodates local substations and control and measuring devices, an intermediate tier accommodates cable overpasses, an upper tier accommodates pipeline overpasses, and an open tier accommodates air-cooled heat exchangers located above all topside modules equipment.

4. The complex according to claim 3, wherein the main technical room and emergency diesel generators module is installed in the same row as the interconnecting modules, and that wherein its open tier accommodates air-cooled heat exchangers.

5. The complex according to claim 1, wherein the GBS has a central part and a protruding part, with the central part being a rectangular prism with the said top slab, the protruding part stretching along the central part sides all around its perimeter and having external vertical walls, the protruding part and the central part sharing the said base slab, and the protruding part being lower in height than the central part.

6. The complex according to claim 5, wherein the GBS central part has internal longitudinal and transverse walls forming compartments, in some of which the said tanks are located and some of which are ballast compartments, while the GBS protruding part has internal walls being perpendicular to its external walls and forming compartments, some of which are ballast compartments.

7. The complex according to claim 5, wherein some of the compartments formed by the GBS central part longitudinal and transverse walls accommodate auxiliary equipment.

8. The complex according to claim 1, wherein the topside modules are mounted on supports located on the top slab above intersections of the GBS central part longitudinal and transverse walls.
